(19) United States
(12) Patent Application Publication
(10) Pub. No.: US 2004/0111249 A1
(43) Pub. Date: Jun. 10, 2004

(54) Simulation method and emulation method

(75) Inventor: Hidetoshi Narahara, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/725,474

(22) Filed: Dec. 3, 2003

(30) Foreign Application Priority Data
Dec. 6, 2002 (JP) 2002-355819

(51) Int. Cl. G06F 9/45

(52) U.S. Cl. 703/22

(57) ABSTRACT

A simulation method of the present invention comprises the steps of recording an executed-row history for each description block of a hardware description; and if the same description block is performed at the same time, deleting a previous executed-row history of the description block performed at the time. With such a feature, an error count in coverage measurement is prevented.

### BACKGROUND OF THE INVENTION

1. Field of the Invention

The present invention relates to a simulation method and an emulation method and, more specifically, to a method for verifying a hardware description language in a design process of a semiconductor device.

2. Description of the Prior Art

In recent years, improvement of efficiency in designing of a semiconductor device has been considered as a more significant factor along with an increase in the scale of semiconductor devices. With such a background, a semiconductor device is designed using a hardware description language that expresses the operation of the semiconductor device as does a programming language.

In the design of a semiconductor device using hardware description, it is necessary to verify whether or not a designed hardware description operates according to the specifications of the semiconductor device. A general structure of a conventional simulation apparatus for performing the verification is shown in FIG. 32. This apparatus includes a simulation execution section 3 and an executed-row counting section 5. The simulation execution section 3 simulates a RTL description 1 based on a test vector 2. The RTL description 1 describes a function of a semiconductor device in a hardware description language. RTL is an abbreviation for a resister transfer level, which is a level of abstraction of description. The test vector 2 is created by a designer of the semiconductor device in accordance with the specifications of the semiconductor device. The designer verifies whether or not the RTL description 1 is appropriately designed while checking in a one-by-one manner whether or not simulation results 4 of the simulation performed by the simulation execution section 3 are identical to the specifications. The executed-row counting section 5 outputs a coverage result 6, which is obtained by counting and observing executed rows of the RTL description 1 in a one-by-one manner during the simulation execution process in order to measure the verification coverage of the test vector 2. The designer specifies unexecuted rows of the RTL description 1 from the coverage result 6 and adds a test vector 2 for re-simulation such that the unexecuted rows are executed, whereby a high-quality semiconductor device with no omission of verification is designed.

In the simulation apparatus of FIG. 32, the simulation execution section 3 performs sequential processing and, therefore, a row which is not functionally executed is instantaneously executed in the simulation. As a result, an error count occurs in the executed-row counting section 5, and the coverage result 6 output from the section 5 has an unduly high coverage. This problem is described with reference to an RTL description example of FIG. 3A and a test vector description example of FIG. 3B.

FIGS. 3A and 3B are examples where Verilog-HDL is used as a hardware description language. The numbers vertically aligned at the left side denote the row numbers of the descriptions. In FIG. 3A, the “always” sentences at the 100th and 113th rows are syntaxes that are executed every time a defined signal changes. Specifically, every time any of “a”, “b”, and “c” at the 100th row changes, the 101st through 110th rows are executed. Such a group of descriptions which perform a series of processes in response to a signal change is herein defined as a description block. The example of FIG. 3A includes two description blocks, i.e., the block of 100th through 111th rows and the block of 113th through 115th rows.

At time 0, the 201st row of FIG. 3B is executed to substitute “a” and “b” with 0 (zero). According to the sequential processing principle, the 100th row and 113th row are then evaluated in response to the change of “a” and “b”. Herein, consider a case where execution is started with the 100th row. In this case, the value of “c” is indefinite while a=0 and b=0. Thus, “out” is not replaced by any particular number, and the process proceeds to the 113th row, at which “c” is replaced by 1 (c=1). Then, in response to the change of “c”, the 100th row is evaluated again. According to the “case” sentence at the 101st row, the 103rd row of {a, b, c}={0, 0, 1} is executed, and “out” is replaced by 0. Then, at time 100, the 202nd row of FIG. 3B is executed, whereby “a” is replaced by 1 (a=1). Then, in response to the change of “a”, the 100th row of FIG. 3A is evaluated. The 107th row of {a, b, c}={1, 0, 1} is executed according to the “case” sentence of the 101st row, and “out” is replaced by 1. Then, the process proceeds to the 113th row, at which “c” is replaced by 0 (c=0). Then, in response to the change of “c”, the 100th row is evaluated again. The 106th row of {a, b, c}={1, 0, 0} is executed according to the “case” sentence of the 101st row, and “out” is replaced by 0. The coverage result of the above process is shown in FIG. 33. FIG. 33 shows the number of times of execution for each row at the left side of the RTL description example of FIG. 3A. In the case where the count is incremented for every sequential execution as described above, the 107th row which is not functionally executed is executed in the simulation and, therefore, a resultant coverage result has an unduly high coverage.

### SUMMARY OF THE INVENTION

An objective of the present invention is to provide a simulation method wherein an error count in coverage measurement in a simulation of a hardware description language is prevented.

The first simulation method of the present invention comprises the steps of: recording executed rows for each description block; and if the same description block is performed at the same time, deleting a previous executed-row history of the description block performed at the time.

According to the above simulation method, an error count in coverage measurement in a simulation of a hardware description language is prevented.

The second simulation method of the present invention comprises the steps of: dividing a hardware description into description blocks; analyzing, for each description block, correspondence information that represents correspondence between combinations of input signals to the description block and executed rows; in a simulation execution process, tracing input signals to each description block; and analyzing the executed rows according to an analysis result of the correspondence information that represents the correspondence between combinations of input signals to the description block and executed rows and a trace result of the input signals to the description block.

According to the above simulation method, the overhead for coverage measurement in a simulation of a hardware description language is reduced.

The third simulation method of the present invention comprises the steps of: dividing a hardware description into description blocks; analyzing, for each description block, correspondence information that represents correspondence between combinations of input signals to the description block and executed rows; in a simulation execution process, tracing input signals to each description block every unit time; and analyzing the executed rows according to an analysis result of the correspondence information that represents the correspondence between combinations of input signals to the description block and executed rows and a trace result of the input signals to the description block, the trace result being obtained every unit time.

According to the above simulation method, an error count in coverage measurement in a simulation of a hardware description language is prevented while the overhead is reduced.

The fourth simulation method of the present invention comprises the steps of: dividing a hardware description into description blocks; analyzing, for each description block, correspondence information that represents correspondence between combinations of input signals to the description block and executed rows; in a simulation execution process, tracing input signals to each description block every cycle; and analyzing the executed rows according to an analysis result of the correspondence information that represents the correspondence between combinations of input signals to the description block and executed rows and a trace result of the input signals to the description block, the trace result being obtained every cycle.

According to the above simulation method, in the case where a semiconductor device to be designed is based on the perfectly synchronous design, an error count in coverage measurement in a simulation of a hardware description language is prevented while the overhead is reduced.

The first emulation method of the present invention comprises the steps of: dividing a hardware description into description blocks; extracting, for each description block, signals used in a hardware emulation process which correspond to input signals to the description block; analyzing correspondence information that represents correspondence between combinations of the signals used in hardware emulation process which correspond to input signals to the description block and executed rows; in an emulation execution process, tracing the signals used in hardware emulation process which correspond to input signals to each description block; and analyzing executed rows according to the correspondence information that represents the correspondence between the combinations of the signals used in the hardware emulation process which correspond to the input signals to the description block and the executed rows and a result of the tracing of the signals used in the hardware emulation process which correspond to the input signals to the description block.

According to the above emulation method, coverage measurement is achieved in a hardware emulation of a hardware description language.

The second emulation method of the present invention comprises the steps of: dividing a hardware description into logic cones; extracting, for each logic cone, signals used in a hardware emulation process which correspond to input signals to the logic cone; analyzing correspondence information that represents correspondence between combinations of the signals used in the hardware emulation process which correspond to input signals to the logic cone and executed rows; in an emulation execution process, tracing the signals used in the hardware emulation process which correspond to input signals to each logic cone; and analyzing executed rows according to the correspondence information that represents the correspondence between the combinations of the signals used in the hardware emulation process which correspond to the input signals to the logic cone and the executed rows and a result of the tracing of the signals used in the hardware emulation process which correspond to the input signals to the logic cone.

According to the above emulation method, coverage measurement is achieved in a hardware emulation of a hardware description language under the condition that an optimization process of circuitry is performed.

The fifth simulation method of the present invention comprises the steps of dividing a hardware description into description blocks; analyzing, for each description block, input conditions for executing respective rows included in the description block; analyzing correspondence information that represents correspondence between the input conditions and executed rows; in a simulation execution process, tracing input signals to each description block; and analyzing executed rows based on the correspondence information that represents the correspondence between the input conditions and the executed rows and a tracing result of the input signal to the description block.

According to the above simulation method, in a simulation of a hardware description language, coverage measurement can be performed on a description block which receives many input signals.

### BRIEF DESCRIPTION OF THE DRAWINGS

FIG. 1 is a block diagram showing a structure of a simulation apparatus according to embodiment 1.

FIG. 2 is a flowchart of a process performed in an executed-row counting section of FIG. 1.

FIG. 3A shows an example of a RTL description. FIG. 3B shows an example of a test vector.

FIG. 4 shows a coverage result.

FIG. 5 is a block diagram showing a structure of a simulation apparatus according to embodiment 2.

FIG. 6 is a flowchart showing a process performed in a block input-executed row correspondence table creating section of FIG. 5.

FIG. 7 shows an example of a block input-executed row correspondence table.

FIG. 8 is a flowchart showing a process performed in an executed-row counting section of FIG. 5.

FIG. 9 is a block diagram showing a structure of a simulation apparatus according to embodiment 3.

FIG. 10 is a flowchart showing a process performed in an executed-row counting section of FIG. 9.

FIG. 11 is a block diagram showing a structure of a simulation apparatus according to embodiment 4.

FIG. 12 is a flowchart showing a process performed in an executed-row counting section of FIG. 11.

FIG. 13 shows an example of a gate level netlist.

FIG. 14 is a block diagram showing a structure of an emulation apparatus according to embodiment 5.

FIG. 15 shows an example of RTL-Gate correspondence information.

FIG. 16 is a flowchart showing an operation performed in a gate level block input-executed row correspondence table creating section of FIG. 14.

FIG. 17 is an example of a gate level block input-executed row correspondence table.

FIG. 18 is a flowchart showing an operation performed in an executed-row counting section of FIG. 14.

FIG. 19 shows an example of a gate level netlist.

FIG. 20 is a block diagram showing a structure of an emulation apparatus according to embodiment 6.

FIG. 21 shows an example of logic cone RTL-Gate correspondence information.

FIG. 22 is a flowchart showing an operation performed in a logic cone input-executed row correspondence table creating section of FIG. 20.

FIG. 23 shows an example of a logic cone input-executed row correspondence table.

FIG. 24 is a flowchart showing an operation performed in an executed-row counting section of FIG. 20.

FIG. 25 is a block diagram showing a structure of a simulation apparatus according to embodiment 7.

FIG. 26 is a flowchart showing an operation performed in a condition-specific block input-executed row correspondence table creating section of FIG. 25.

FIG. 27 shows an example of a RTL description.

FIG. 28 shows an example of a condition-specific block input-executed row correspondence table.

FIG. 29 is a flowchart showing an operation performed in an executed-row counting section of FIG. 25.

FIG. 30 shows an example of a test vector.

FIG. 31 shows a coverage result.

FIG. 32 is a block diagram showing a structure of a conventional simulation apparatus.

FIG. 33 shows a coverage result.

### DESCRIPTION OF THE PREFERRED EMBODIMENTS

Hereinafter, embodiments of the present invention are described with reference to the drawings. It should be noted that identical or equivalent elements are denoted by the same reference numerals throughout the drawings, and descriptions thereof are not repeated.

### Embodiment 1

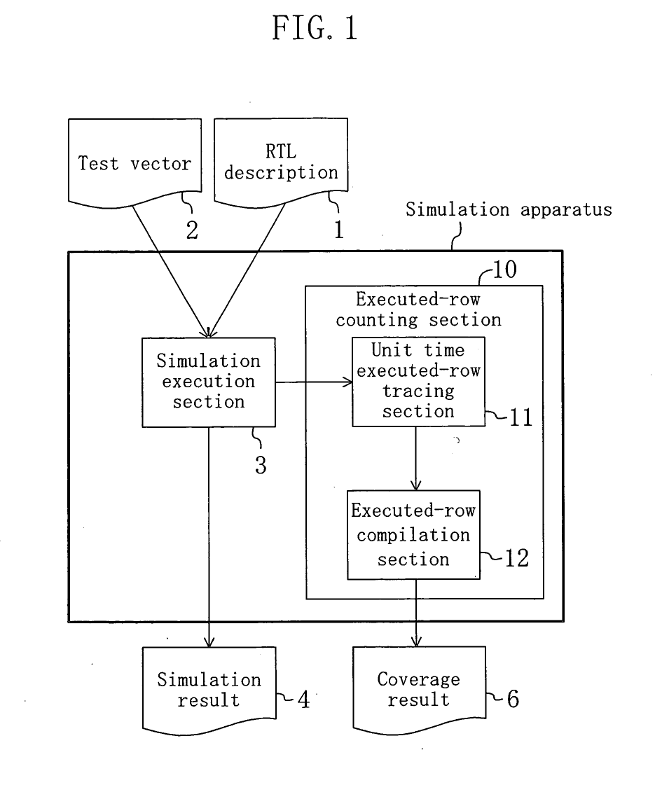

FIG. 1 shows a structure of a simulation apparatus according to embodiment 1. The simulation apparatus includes a simulation execution section 3 and an executed-row counting section 10.

The simulation execution section 3 simulates a RTL description 1 based on a test vector 2. The RTL description 1 describes a function of a semiconductor device in a hardware description language. RTL is an abbreviation for a resister transfer level, which is a level of abstraction of description. The test vector 2 is created by a designer of the semiconductor device in accordance with the specifications of the semiconductor device.

The executed-row counting section 10 includes a unit time executed-row tracing section 11 and an executed-row compilation section 12.

The unit time executed-row tracing section 11 receives executed-row information from the simulation execution section 3 and extracts executed rows for each description block every unit time. The unit time is the minimum time that can be designated by the designer.

The executed-row compilation section 12 counts the number of times of execution for each row based on the executed-row information extracted from the unit time executed-row tracing section 11 and outputs a coverage result 6 after the simulation execution process is completed.

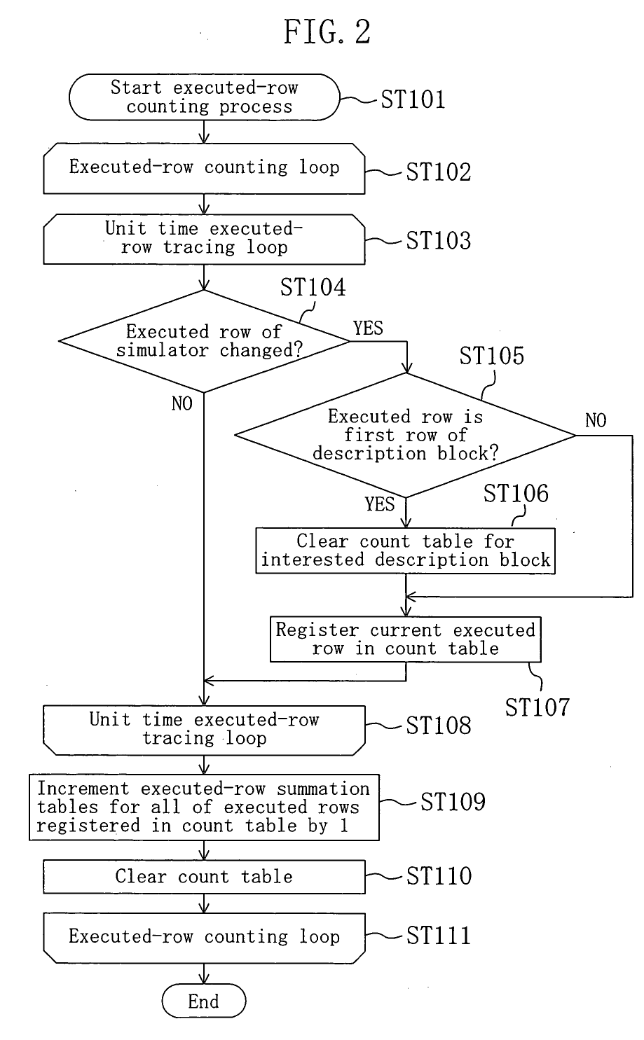

Next, a process performed in the executed-row counting section 10 is described with reference to FIG. 2.

At the same time with the start of the simulation execution process performed by the simulation execution section 3, an executed row counting process is started (ST101). After the counting is started, the executed row counting loop (ST102 to ST111) is repeated until the end of the simulation execution process, while the unit time executed-row trace loop (ST103 to ST108) is repeated till the simulation time is updated.

At step ST104, current execution information is received from the simulation execution section 3, and it is checked whether or not the row executed by the simulator has been changed. If not, the unit time executed-row trace loop which starts from step ST103 is performed till the simulation time is updated. If the executed row has been changed at step ST104, it is checked whether or not the current executed row is the first row of the description block (ST105). If it is the first row of the description block, a count table for the description block that includes the current executed row is cleared (ST106). The count table is provided for storing an execution history of each description block every unit time. Then, the current executed row is registered in the count table (ST107). If it is not the first block at ST105, the current executed row is registered in the count table without clearing the count table (ST107). Then, the unit time executed-row trace loop that starts from step ST103 is performed again till the simulation time is updated. The process of step ST103 to step ST108 is performed in the unit time executed-row tracing section 11.

When the simulation time is updated, executed-row summation tables for all of the executed rows registered in the count table are each incremented by 1 (ST109). This processing is performed in the executed-row compilation section 12. The executed-row summation table is provided to each row for storing the number of times of execution of the row. Then, the count table is cleared at step ST110. The process returns to the executed-row counting loop that starts from step ST102 to repeat the executed-row counting process till the simulation execution process is completed.

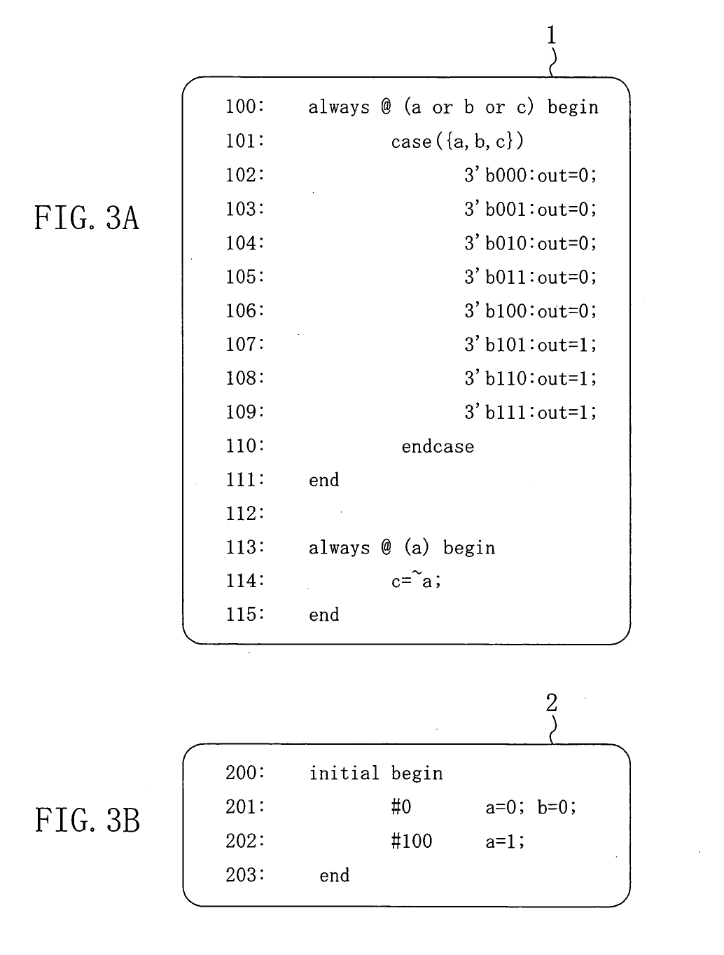

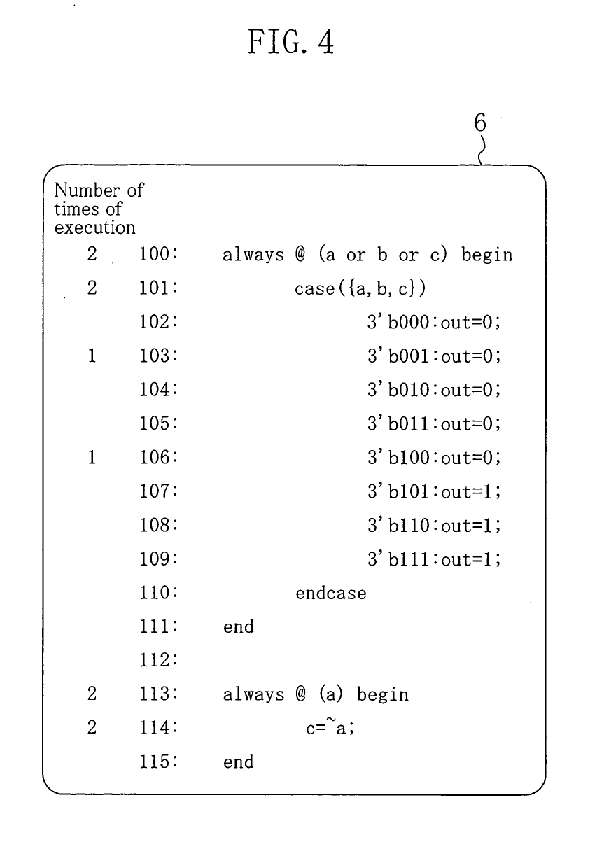

FIG. 4 shows a coverage result which is obtained when the executed-row counting process is performed on the RTL description 1 shown in FIG. 3A and the test vector 2 shown in FIG. 3B.

As described above, according to embodiment 1, only the executed row history of the row which has been functionally executed every unit time is extracted by the unit time executed-row tracing section 11. Thus, the correct coverage result 6 which includes no error count can be obtained.

### Embodiment 2

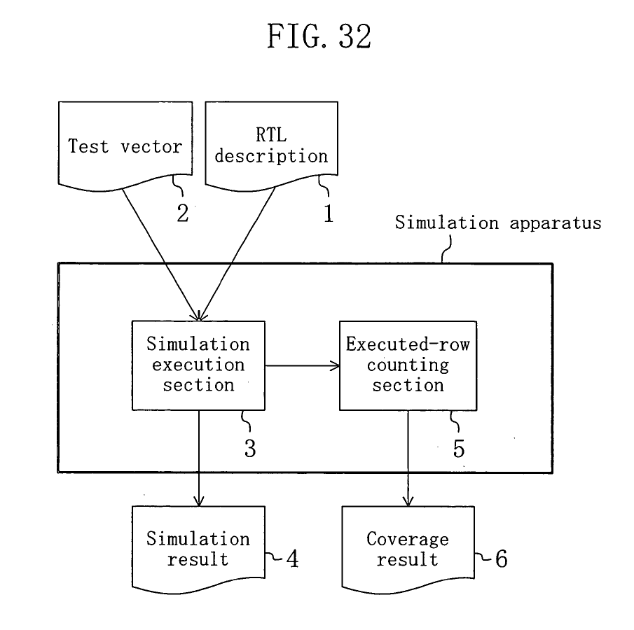

In the conventional simulation apparatus shown in FIG. 32, the process of tracing rows executed in a simulation is performed on every executed row on an executed-row by executed-row basis. Thus, an overhead is caused in the simulation execution process every time the executed row is updated, whereby the simulation speed is decreased. An objective of embodiment 2 is to reduce the overhead for the coverage measurement in the simulation of a hardware description language.

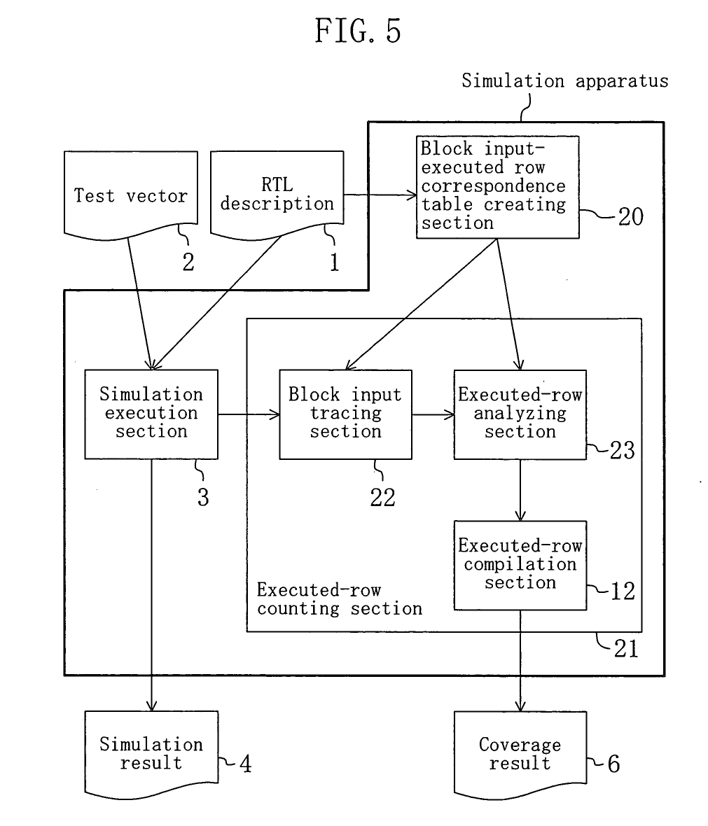

FIG. 5 shows a structure of a simulation apparatus according to embodiment 2. This simulation apparatus includes a simulation execution section 3, a block input-executed row correspondence table creating section 20 and an executed-row counting section 21.

The block input-executed row correspondence table creating section 20 divides the RTL description 1 into description blocks and analyzes for each description block the correspondence between the combinations of input signals to the block and the executed rows, thereby extracting correspondence information that represents the correspondence between the combinations of input signals to the block and the executed rows.

The executed-row counting section 21 includes a block input tracing section 22, an executed-row analyzing section 23 and an executed-row compilation section 12.

The block input tracing section 22 receives input signal information from the simulation execution section 3 every time any input signal to a description block obtained in the block input-executed row correspondence table creating section 20 is changed.

The executed-row analyzing section 23 extracts an executed row based on the input signal information received by the block input tracing section 22 and the correspondence information that represents the correspondence between the combinations of input signals to the block and the executed rows which has been extracted by the block input-executed row correspondence table creating section 20.

The executed-row compilation section 12 counts the number of times of execution for each row based on the executed-row information extracted by the executed-row analyzing section 23 and outputs the coverage result 6 after the simulation execution process is completed.

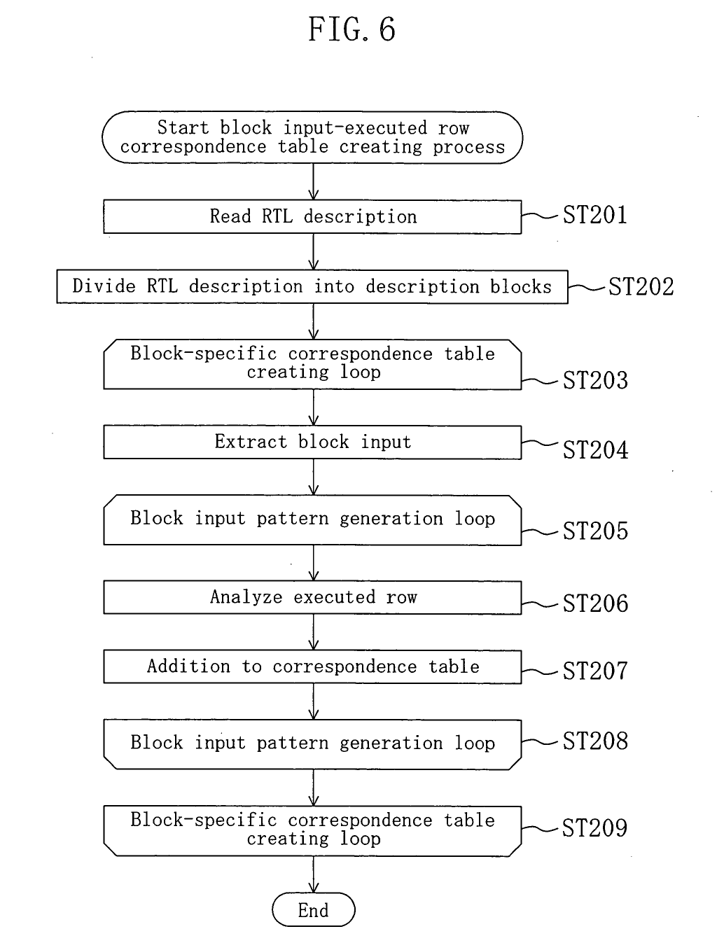

Next, a process performed in the block input-executed row correspondence table creating section 20 is described with reference to FIG. 6.

In the first place, the simulation apparatus reads the RTL description 1 (ST201). Herein, it is assumed that the simulation apparatus reads the RTL description shown in FIG. 3A.

Then, the read RTL description 1 is divided into description blocks (ST202). Through this process, the read RTL description 1 is divided into the description block of the 100th to 110th rows and the description block of the 113th to 115th rows (see FIG. 3A). The process of a block-specific correspondence table creation loop of subsequent steps ST203 to ST209 is performed on all of the description blocks obtained at step ST202.

Then, the input signals to a description block that is to be processed (target description block) are extracted (ST204). When the target description block is the description block of the 113th to 115th rows, the input signals to the block are “a”, “b” and “c” (see FIG. 3A). The process of a block input pattern generation loop of subsequent steps ST205 to ST208 is performed on all of the combinations of input signals to the block which are extracted at step ST204. In the case of the description block of the 113th to 115th rows, the process of the block input pattern generation loop is performed on 8 combinations of {a, b, c}={0, 0, 0} to {1, 1, 1}.

Then, executed rows of the target description block for a target combination pattern are analyzed (ST206). In the case where the target pattern is {a, b, c}={0, 0, 0}, the executed rows are the 100th, 101st and 102nd rows (see FIG. 3A).

Then, the correspondence between the input signals to the block and the executed rows, which has been obtained at step ST206, is added to the block input-executed row correspondence table (ST207).

Then, the combination of the block input signals is changed, and the process returns to the loop of steps ST205 to ST208. After the process has been done for all of the combinations, the process proceeds to a next description block to perform the loop of steps ST203 to ST209.

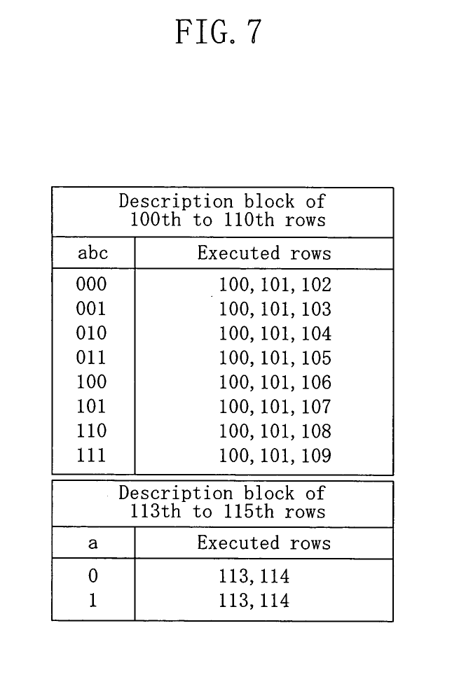

FIG. 7 shows a block input-executed row correspondence table obtained by performing the above process on the RTL description shown in FIG. 3A.

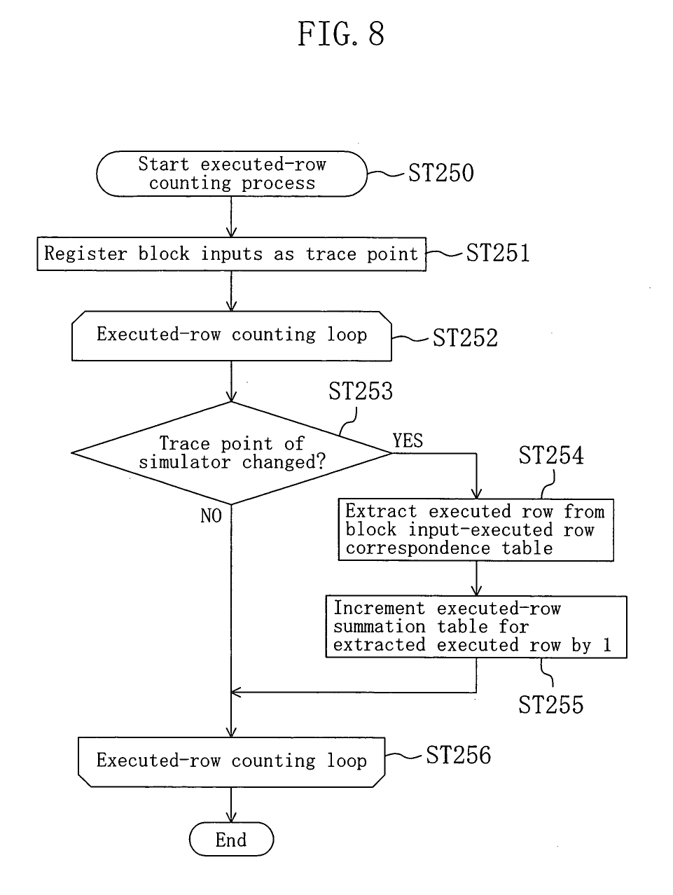

Then, the executed-row counting process performed in the executed-row counting section 21 is described with reference to FIG. 8.

The executed-row counting process is started at the same time with the start of the simulation execution process performed by the simulation execution section 3 (ST250).

Then, the input signals to each of the blocks obtained in the block input-executed row correspondence table creating section 20 are registered as a trace point used in the simulation execution process (ST251).

The executed-row counting loop of subsequent steps ST252 to ST256 is continued till the simulation execution process is completed.

Then, it is checked whether or not the trace point has been changed in the simulation execution process (ST253). The above-described process up to step ST253 is performed in the block input tracing section 22.

If the trace point has not been changed at step ST253, the process directly returns to the loop that starts from step ST252. If the trace point has been changed, the executed rows are extracted according to the value of the trace point and the block input-executed row correspondence table obtained from the block input-executed row correspondence table creating section 20 (ST254). This process is executed in the executed-row analyzing section 23.

Then, the executed-row summation tables for all of the executed rows extracted at step ST254 are each incremented by 1 (ST255). This process is performed in the executed-row compilation section 12. Then, the process returns to the executed-row counting loop that starts from step ST252 to perform the executed-row counting process till the simulation execution process is completed.

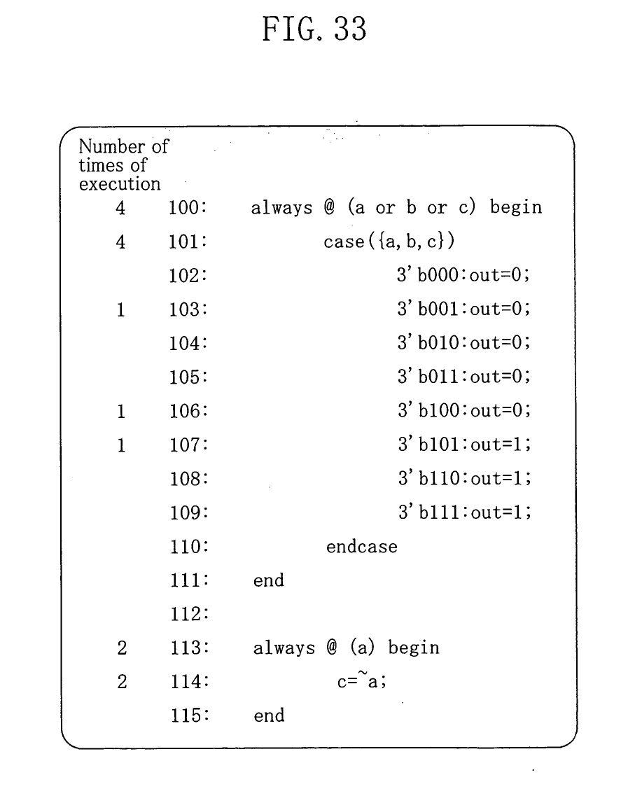

The coverage result 6 obtained by performing the above-described executed-row counting process on the RTL description 1 shown in FIG. 3A and the test vector 2 shown in FIG. 3B is the same as the conventional coverage result shown in FIG. 33. However, in embodiment 2, only the input signals to the description block are traced by the block input tracing section 22, whereas in the conventional simulation apparatus shown in FIG. 32 the process of tracing rows executed in a simulation is performed on every executed row on an executed-row by executed-row basis, whereby an overhead is caused in the simulation execution process every time the executed row is updated and, accordingly, the simulation speed is decreased. Thus, the structure of embodiment 2 overcomes such a problem of the conventional simulation apparatus. That is, the overhead for the coverage measurement in the simulation of a hardware description language is reduced.

### Embodiment 3

In the conventional simulation apparatus shown in FIG. 32, the simulation execution section 3 performs sequential processing and, therefore, a row which is not functionally executed is instantaneously executed in the simulation. As a result, an error count occurs in the executed-row counting section 5, and there is a possibility that the coverage result 6 output from the section 5 has an unduly high coverage. Moreover, the process of tracing rows executed in the simulation is performed on every executed row on an executed-row by executed-row basis. Thus, an overhead is caused in the simulation execution process every time the executed row is updated and, accordingly, the simulation speed is decreased. An objective of embodiment 3 is to prevent an error count in the coverage measurement in the simulation of a hardware description language while reducing the overhead.

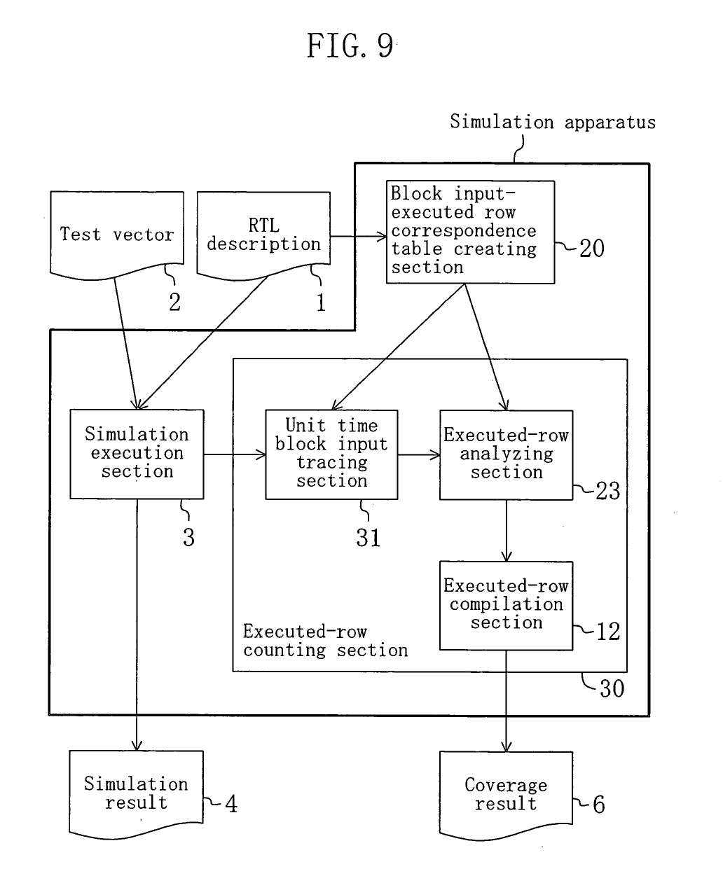

FIG. 9 shows a structure of a simulation apparatus according to embodiment 3. This simulation apparatus includes a simulation execution section 3, a block input-executed row correspondence table creating section 20 and an executed-row counting section 30.

The executed-row counting section 30 includes a unit time block input tracing section 31, an executed-row analyzing section 23 and an executed-row compilation section 12.

The unit time block input tracing section 31 receives from the simulation execution section 3 a change in the input signals to a description block which is obtained in the block input-executed row correspondence table creating section 20.

The executed-row analyzing section 23 extracts executed rows according to the information about the input signal received by the unit time block input tracing section 31 and the correspondence information that represents the correspondence between the combinations of input signals to the block and the executed rows which has been extracted by the block input-executed row correspondence table creating section 20.

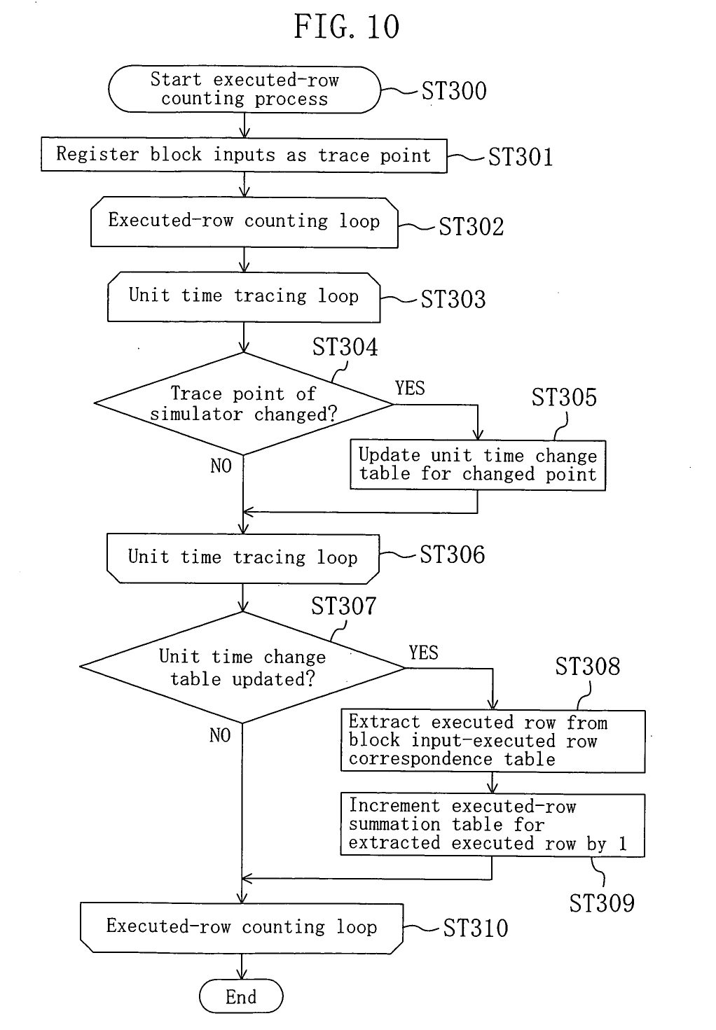

Next, a process performed in the executed-row counting section 30 is described with reference to FIG. 10.

At the same time with the start of a simulation execution process performed by the simulation execution section 3, an executed row counting process is started (ST300).

Then, the input signals to each of the blocks obtained in the block input-executed row correspondence table creating section 20 are registered as a trace point used in the simulation execution process (ST301).

The executed-row counting loop of subsequent steps ST302 to ST310 is continued till the simulation execution process is completed. The unit time tracing loop of steps ST303 to ST306 is repeated till the simulation time is updated.

Then, it is checked whether or not the trace point has been changed in the simulation execution process (ST304). If not, the process returns to the loop that starts from step ST303. If the trace point has been changed, a unit time change table for the description block that includes the changed trace point is updated, and the process returns to the loop that starts from step ST303 (ST305). The unit time change table is provided for storing the values of input signals to each description block every unit time.

When the simulation time is updated, it is checked whether or not the unit time change table of each description block has been updated (ST307). The above-described process up to step ST307 is performed in the unit time block input tracing section 31.

If the unit time change table has not been updated at step ST307, the process returns to the loop that starts from step ST302. If the unit time change table has been updated, executed rows are according to the value of the updated unit time change table and the block input-executed row correspondence table obtained from the block input-executed row correspondence table creating section 20 (ST308). This process is performed in the executed-row analyzing section 23.

Then, the executed-row summation tables for all of the executed rows extracted at step ST308 are each incremented by 1 (ST309). This process is performed in the executed-row compilation section 12. Then, the process returns to the executed-row counting loop that starts from step ST302 to perform the executed-row counting process till the simulation execution process is completed.

A coverage result obtained by performing the above-described executed-row counting process on the RTL 1 description shown in FIG. 3A and the test vector 2 shown in FIG. 3B is the same as the coverage result 6 shown in FIG. 4.

As described above, in embodiment 3, only the information about the input signals to the description block which are functionally changed every unit time is extracted by the unit time block input tracing section 31. Therefore, the correct coverage result 6 which includes no error count can be obtained. Moreover, according to embodiment 3, only the input signals to the description block are traced by the unit time block input tracing section 31. Such a feature avoids the problems of the conventional simulation apparatus that an overhead is caused in the simulation execution process every time the executed row is updated and, accordingly, the simulation speed is decreased. That is, the overhead for the coverage measurement in the simulation of a hardware description language is reduced.

### Embodiment 4

In the conventional simulation apparatus shown in FIG. 32, the simulation execution section 3 performs sequential processing and, therefore, a row which is not functionally executed is instantaneously executed in the simulation. As a result, an error count occurs in the executed-row counting section 5, and there is a possibility that the coverage result 6 output from the section 5 has an unduly high coverage. Moreover, the process of tracing rows executed in the simulation is performed on every executed row on an executed-row by executed-row basis. Thus, an overhead is caused in the simulation execution process every time the executed row is updated and, accordingly, the simulation speed is decreased. An objective of embodiment 4 is to prevent an error count in the coverage measurement in the simulation of a hardware description language while reducing the overhead, in the case where a semiconductor device to be designed is based on the perfectly synchronous design.

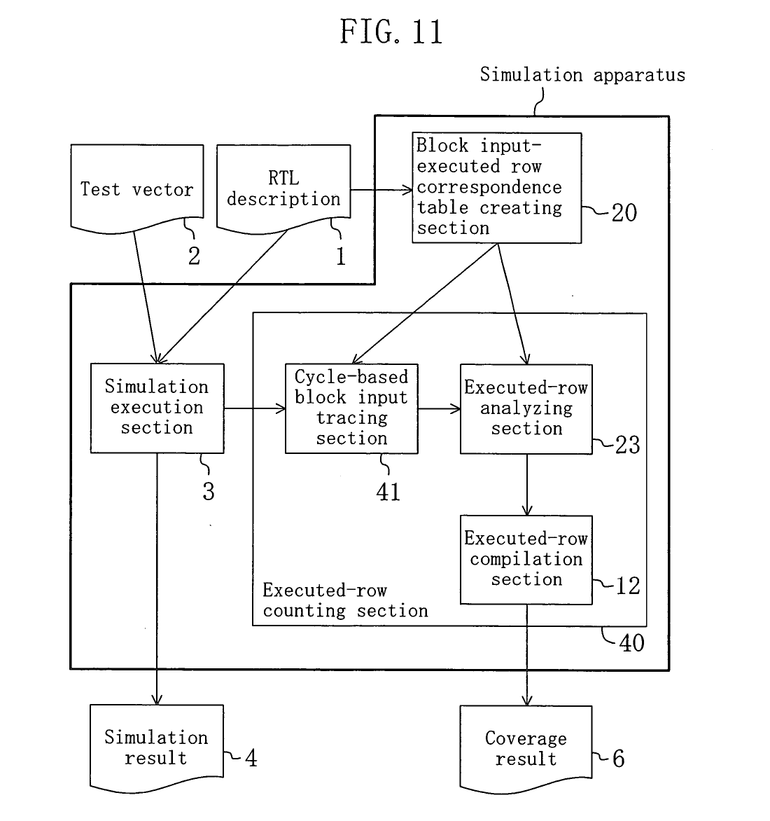

FIG. 11 shows a structure of a simulation apparatus according to embodiment 4. This simulation apparatus includes a simulation execution section 3, a block input-executed row correspondence table creating section 20 and an executed-row counting section 40.

The executed-row counting section 40 includes a cycle-based block input tracing section 41, an executed-row analyzing section 23 and an executed-row compilation section 12.

The cycle-based block input tracing section 41 receives from the simulation execution section 3 a change in the input signals to a description block which is obtained in the block input-executed row correspondence table creating section 20 as input signal information every cycle.

The executed-row analyzing section 23 extracts executed rows according to the input signal information received by the cycle-based block input tracing section 41 and the correspondence information that represents the correspondence between the combinations of input signals to the block and the executed rows which has been extracted by the block input-executed row correspondence table creating section 20.

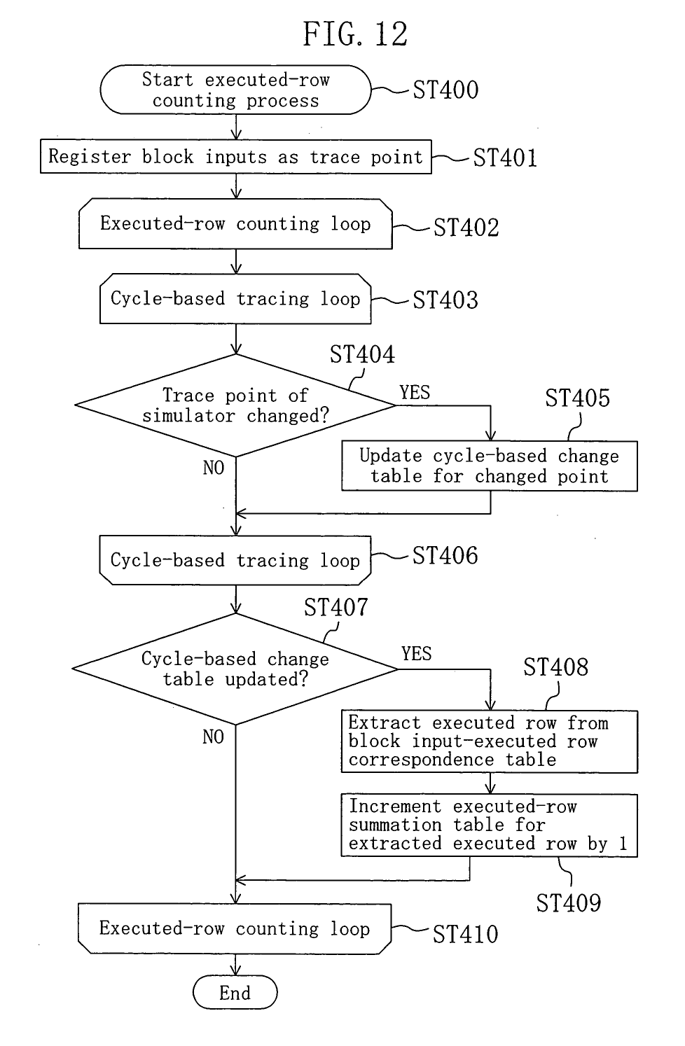

Next, a process performed in the executed-row counting section 40 is described with reference to FIG. 12.

At the same time with the start of a simulation execution process performed by the simulation execution section 3, an executed row counting process is started (ST400).

Then, the input signals to each of the blocks obtained in the block input-executed row correspondence table creating section 20 are registered as a trace point used in the simulation execution process (ST401).

The executed-row counting loop of subsequent steps ST402 to ST410 is continued till the simulation execution process is completed. The unit time tracing loop of steps ST403 to ST406 is repeated till the simulation time is updated to the next cycle.

Then, it is checked whether or not the trace point has been changed in the simulation execution process (ST404). If not, the process returns to the loop that starts from step ST403. If the trace point has been changed, a cycle-based change table for the description block that includes the changed trace point is updated, and the process returns to the loop that starts from step ST403 (ST405). The cycle-based change table is provided for storing the values of input signals to each description block every unit time.

When the simulation time is updated to the next cycle, it is checked whether or not the cycle-based change table of each description block has been updated (ST407). The above-described process up to step ST407 is performed in the cycle-based block input tracing section 41.

If the cycle-based change table has not been updated at step ST407, the process returns to the loop that starts from step ST402. If the cycle-based change table has been updated, executed rows are extracted according to the value of the updated cycle-based change table and the block input-executed row correspondence table obtained from the block input-executed row correspondence table creating section 20 (ST408). This process is performed in the executed-row analyzing section 23.

Then, the executed-row summation tables for all of the executed rows extracted at step ST408 are each incremented by 1 (ST409). This process is performed in the executed-row compilation section 12. Then, the process returns to the executed-row counting loop that starts from step ST402 to perform the executed-row counting process till the simulation execution process is completed.

A coverage result obtained by performing the above-described executed-row counting process on the RTL description 1 shown in FIG. 3A and the test vector 2 shown in FIG. 3B is the same as the coverage result 6 shown in FIG. 4.

As described above, in embodiment 4, the cycle-based block input tracing section 41 extracts only the information about the input signals to the description block which are functionally changed every cycle. Therefore, the correct coverage result 6 which includes no error count can be obtained. Moreover, according to embodiment 4, only the input signals to the description block are traced by the cycle-based block input tracing section 41. Such a feature avoids the problems of the conventional simulation apparatus that an overhead is caused in the simulation execution process every time the executed row is updated and, accordingly, the simulation speed is decreased. Furthermore, the executed-row analyzing section 23 and the executed-row compilation section 12 operate only on a cycle basis. Thus, the process speed is further improved as compared with the simulation method of embodiment 3.

### Embodiment 5

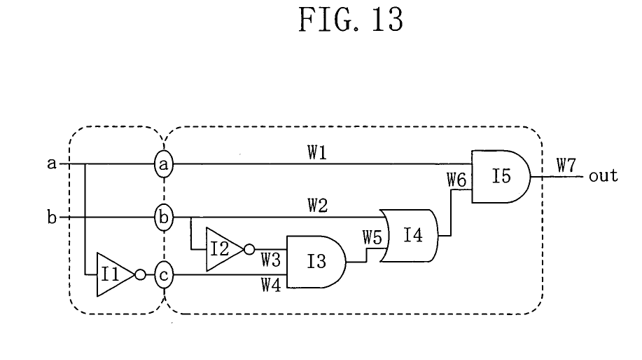

In the designing of a semiconductor device using a hardware description, a hardware emulator is sometimes used in place of a software-based simulator in order to verify that a designed hardware description operates as per the specifications of the semiconductor device. The hardware emulator can perform verification 10,000 or more times faster than a software-based simulator can. Next, a general structure of such a hardware emulator is described. In the hardware emulator, a RTL description to be verified is converted to gate level data through a logic construction process, and the gate level data is replaced with actual hardware, such as a FPGA, or the like, whereby the operation of the RTL description is emulated at high speed. For example, the RTL description shown in FIG. 3A is replaced with a gate level netlist of FIG. 13. In the gate level netlist of FIG. 13, I1 through 15 are instance names which are inherently assigned to respective circuit elements; W1 through W7 are names which are inherently assigned to nodes used for connecting the circuit elements. However, the emulation process does not include the concept of “executing a row” and therefore cannot measure the coverage.

An objective of embodiment 5 is to achieve coverage measurement in a hardware emulation of a hardware description language.

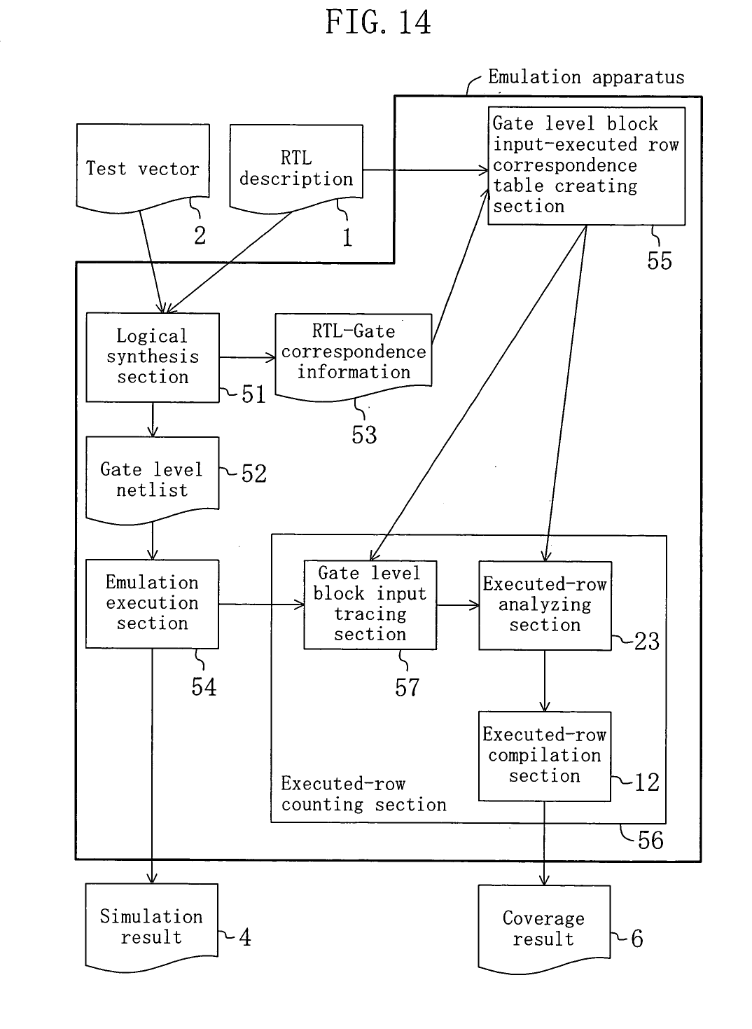

FIG. 14 shows a structure of an emulation apparatus according to embodiment 5. This emulation apparatus includes a logical synthesis section 51, an emulation execution section 54, a gate level block input-executed row correspondence table creating section 55 and an executed-row counting section 56.

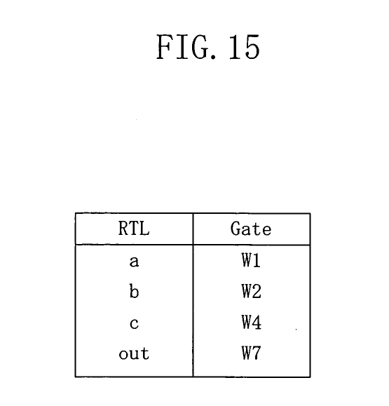

The logical synthesis section 51 converts a RTL description 1 to a gate level netlist 52 in order to replace the RTL description 1 with hardware. In the case of the RTL description shown in FIG. 3A, the RTL description is converted to the gate level netlist of FIG. 13. While converting the RTL description to the gate level netlist, the logical synthesis section 51 outputs RTL-Gate correspondence information 53 that represents a correspondence between the RTL description 1 and the gate level netlist 52. FIG. 15 shows RTL-Gate correspondence information for the case of the RTL description shown in FIG. 3A.

The emulation execution section 54 has a function equivalent to the simulation execution section 3 of embodiments 1-4.

The gate level block input-executed row correspondence table creating section 55 divides the RTL description 1 into description blocks and analyzes the correspondence for each description block between the combinations of input signals to the block and the executed rows in the emulation execution section 54 using the RTL-Gate correspondence information 53, thereby extracting correspondence information that represents the correspondence between the combinations of input signals to the block and the executed rows in the emulation execution section 54.

The executed-row counting section 56 includes a gate level block input tracing section 57, an executed-row analyzing section 23 and an executed-row compilation section 12.

The gate level block input tracing section 57 receives from the emulation execution section 54 a change in the input signals to a description block, which is obtained in the gate level block input-executed row correspondence table creating section 55, in the emulation execution section 54.

The executed-row analyzing section 23 extracts executed rows according to the input signal information received by the gate level block input tracing section 57 and the correspondence information that represents the correspondence between the combinations of input signals to the block which are employed in the emulation execution section 54 and the executed rows which has been extracted by the gate level block input-executed row correspondence table creating section 55.

The executed-row compilation section 12 counts the number of times of execution for each row based on the executed-row information extracted from the executed-row analyzing section 23 and outputs a coverage result 6 after the emulation execution process is completed.

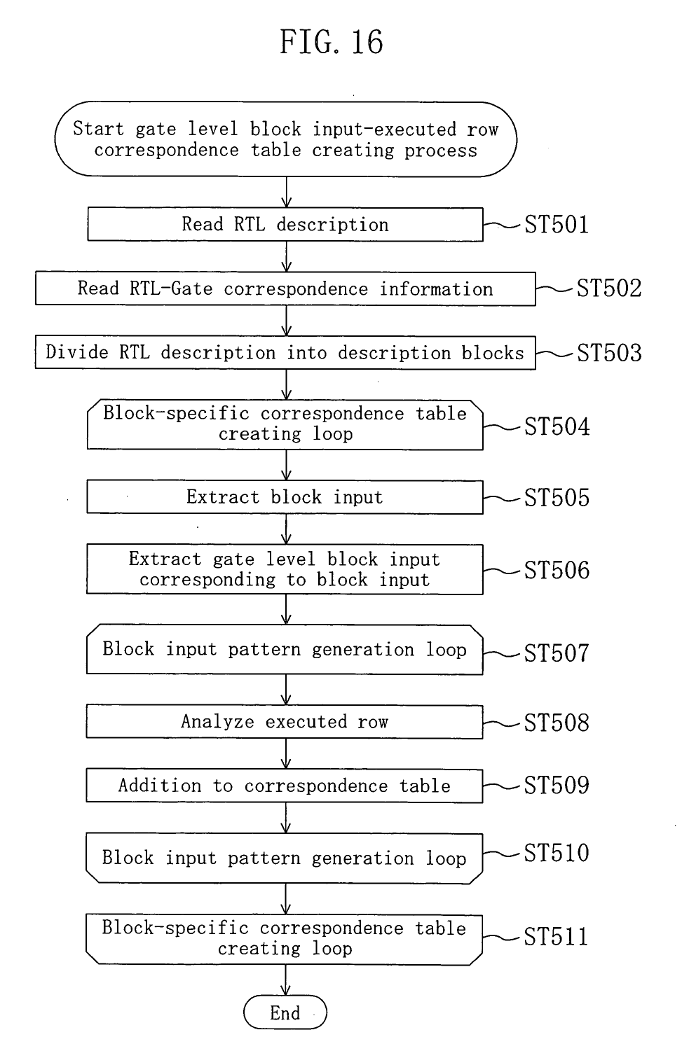

Next, a process performed in the gate level block input-executed row correspondence table creating section 55 is described with reference to FIG. 16.

In the first place, the emulation apparatus reads the RTL description 1 (ST501). Herein, it is assumed that the emulation apparatus reads the RTL description shown in FIG. 3A.

Then, the gate level block input-executed row correspondence table creating section 55 reads the RTL-Gate correspondence information 53 (ST502).

Then, the RTL description 1 read at step ST501 is divided into description blocks (ST503). Through this process, the RTL description 1 is divided into description blocks of the 100th to 110th rows and description blocks of the 113th to 115th rows (see FIG. 3A). The process of a block-specific correspondence table creation loop of subsequent steps ST504 to ST511 is performed on every description block obtained at step ST503.

Then, input signals to a description block to be processed are extracted (ST505). When the description block to be processed is the description block of the 113th to 115th rows, the input signals to the block are “a”, “b” and “c” (see FIG. 3A).

Then, signals for use in the emulation execution section 54, which correspond to the input signals to the block extracted at step ST505, are extracted (ST506). Hereinafter, the signals for use in the emulation execution section 54 which correspond to the input signals to the block are referred to as “gate level block inputs”. The process of a block input pattern generation loop of subsequent steps ST507 to ST510 is performed on all of the combinations of input signals to the block extracted at step ST505. In the case of the description block of the 113th to 115th rows, the process of the block input pattern generation loop is performed on 8 combinations of {a, b, c}={W1, W2, W4}={0, 0, 0} to {1, 1, 1} (see FIG. 3A and FIG. 15).

Then, executed rows of a target description block for a target combination pattern are analyzed (ST508). In the case where the target pattern is {a, b, c}={W1, W2, W4}={0, 0, 0}, the executed rows are the 100th, 101st and 102nd rows.

Then, the correspondence between the input signals to the block (block inputs) and the executed rows, which has been obtained at step ST508, is added to the gate level block input-executed row correspondence table (ST509).

Then, the combination of the block inputs is changed, and the process returns to the loop of steps ST507 to ST510. After all of the combinations have been processed, the process proceeds to a next description block, and the loop of steps ST504 to ST511 is performed.

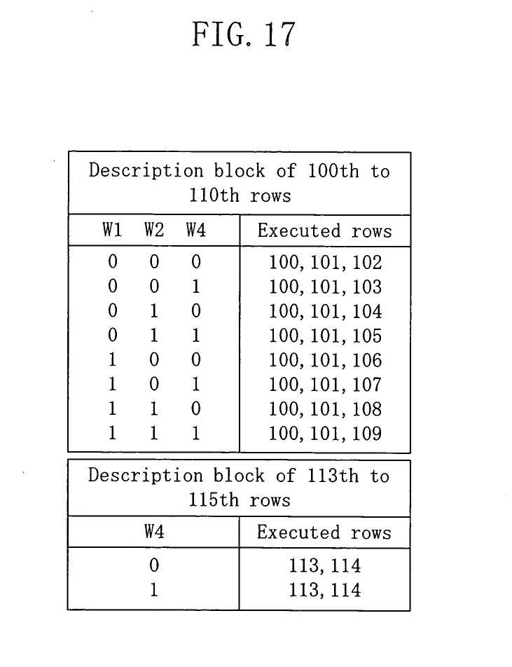

FIG. 17 shows a gate level block input-executed row correspondence table obtained by performing the above process on the RTL description shown in FIG. 3A.

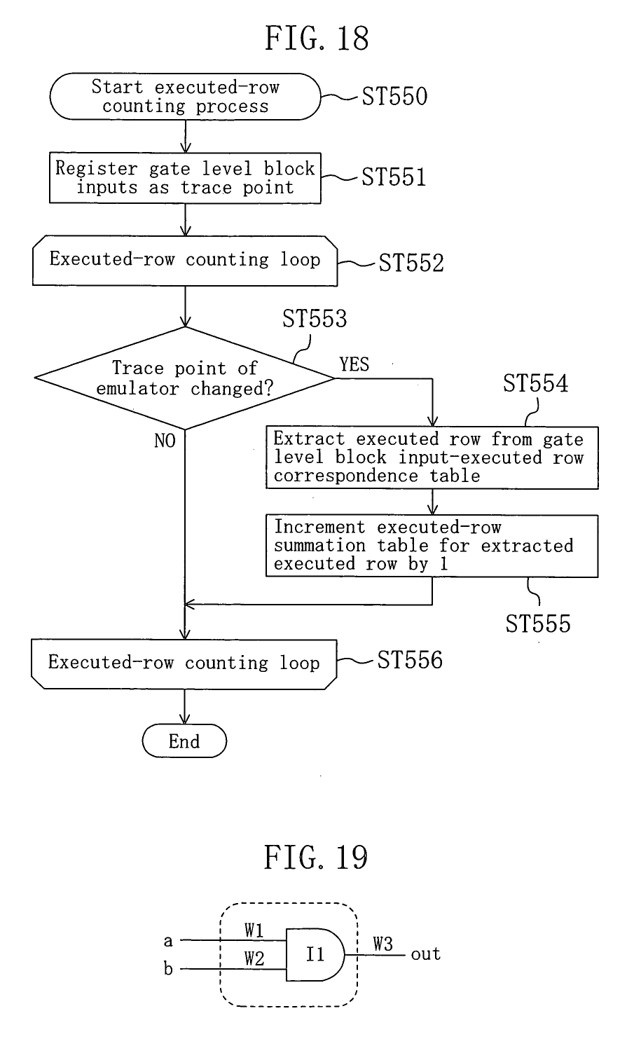

Next, a process performed in the executed-row counting section 56 is described with reference to FIG. 18.

The executed-row counting process is started at the same time with the start of the emulation execution process performed by the emulation execution section 54 (ST550).

Then, the gate level block inputs to each of the blocks obtained in the gate level block input-executed row correspondence table creating section 55 are registered as a trace point used in the emulation execution process (ST551). The executed-row counting loop of subsequent steps ST552 to ST556 is continued till the emulation execution process is completed.

Then, it is checked whether or not the trace point has been changed in the emulation execution process (ST553). The above-described process up to step ST553 is performed in the gate level block input tracing section 57.

If the trace point has not been changed at step ST553, the process returns to the loop that starts from step ST552. If the trace point has been changed, the executed rows are extracted according to the value of the changed trace point and the gate level block input-executed row correspondence table obtained from the gate level block input-executed row correspondence table creating section 55 (ST554). This process is executed in the executed-row analyzing section 23.

Then, the executed-row summation tables for all of the executed rows extracted at step ST554 are each incremented by 1 (ST555). This process is performed in the executed-row compilation section 12.

Hereinafter, the process returns to the executed-row counting loop that starts from step ST552 to repeat the executed-row counting process till the emulation execution process is completed.

A coverage result obtained by performing the above-described executed-row counting process on the RTL description 1 shown in FIG. 3A and the test vector 2 shown in FIG. 3B is the same as the coverage result 6 shown in FIG. 4.

As described above, according to embodiment 5, the executed rows of the RTL description 1 are estimated based on the gate level block input-executed row correspondence table obtained from the gate level block input-executed row correspondence table creating section 55 and the process of tracing signals corresponding to the block inputs of the emulation execution section 54. Thus, the coverage observation, which cannot be measured in the conventional emulation methods, is achieved. Furthermore, the emulation execution process is not a sequential process, whereas a software simulation process is sequential. Therefore, the correct coverage result 6 which has no error count is achieved in the emulation execution process.

### Embodiment 6

In the emulation apparatus shown in FIG. 14, the logical synthesis section 51 converts the RTL description 1 to the gate level netlist 52. In this conversion process, optimization of the logic is performed in some cases in order to reduce the number of circuit elements used in the hardware. FIG. 19 shows a gate level netlist obtained when an optimization process is performed on the RTL description of FIG. 3A. By this optimization process, the scale of circuitry corresponding to the emulation execution process is increased and, accordingly, the speed of the emulation process is increased. However, the gate level block inputs, which correspond to the input signals to the description block of the RTL description 1, are deleted through the optimization process and, as a result, the emulation method described in embodiment 5 becomes inapplicable. An objective of embodiment 6 is to achieve coverage measurement in a hardware emulation of a hardware description language under the condition that the optimization process of circuitry is performed.

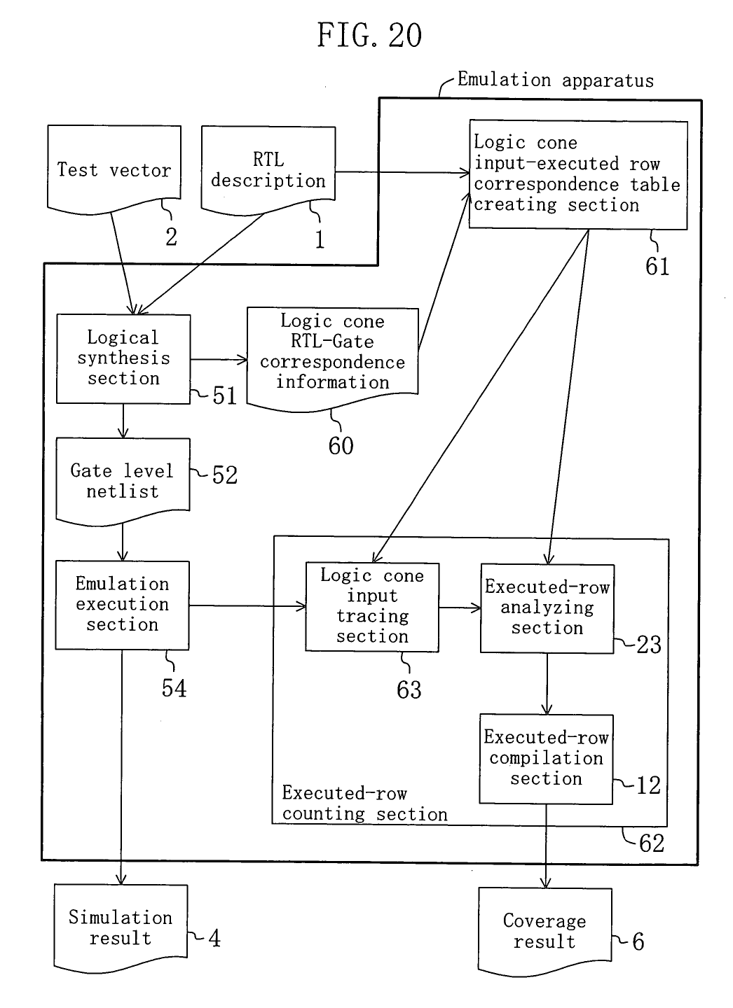

FIG. 20 shows a structure of an emulation apparatus according to embodiment 6. This emulation apparatus includes a logical synthesis section 51, an emulation execution section 54, a logic cone input-executed row correspondence table creating section 61 and an executed-row counting section 62.

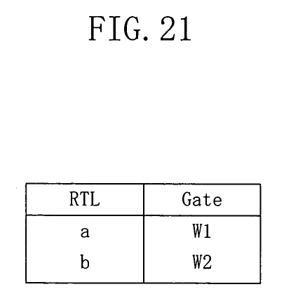

When converting a RTL description 1 to a gate level netlist 52, the logical synthesis section 51 outputs signal information 60 of the RTL description which corresponds to input signals to the respective logic cones of the gate level netlist 52 (logic cone RTL-Gate correspondence information). Herein, “logic cone” is defined as below. For example, in a logic circuit consisting of memory elements, such as a flip-flop, or the like, and combinational circuits, a combinational circuit which affects input terminals of the respective memory elements or an output terminal of the logic circuit is referred to as a “logic cone”. FIG. 21 shows logic cone RTL-Gate correspondence information 60 obtained when a logical synthesis process is performed on the RTL description shown in FIG. 3A.

The logic cone input-executed row correspondence table creating section 61 divides the RTL description 1 among logic cones by using the logic cone RTL-Gate correspondence information 60 and extracts, for each logic cone, correspondence information that represents the correspondence between the combinations of logic cone input signals used in the emulation execution section 54 and the executed rows of the RTL description 1.

The executed-row counting section 62 includes a logic cone input tracing section 63, an executed-row analyzing section 23 and an executed-row compilation section 12.

The logic cone input tracing section 63 receives from the emulation execution section 54 information about a change in the logic cone inputs in the emulation execution section 54.

The executed-row analyzing section 23 extracts executed rows according to the input signal information received by the logic cone input tracing section 63 and the correspondence information that represents the correspondence between the combinations of input signals to the logic cone in the emulation execution section 54 and the executed rows which has been extracted by the logic cone input-executed row correspondence table creating section 61.

The executed-row compilation section 12 counts the number of times of execution for each row based on the executed-row information extracted from the executed-row analyzing section 23 and outputs a coverage result 6 after the emulation execution process is completed.

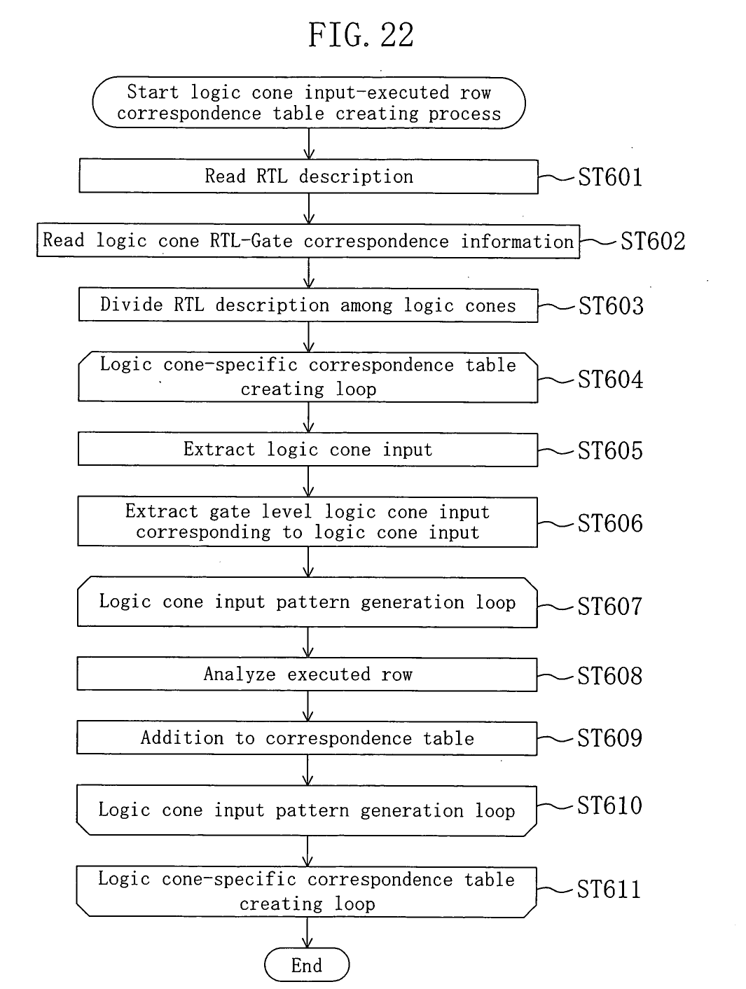

Next, a process performed in the logic cone input-executed row correspondence table creating section 61 is described with reference to FIG. 22.

In the first place, the emulation apparatus reads the RTL description 1 (ST601). Herein, it is assumed that the emulation apparatus reads the RTL description shown in FIG. 3A.

Then, the logic cone input-executed row correspondence table creating section 61 reads the logic cone RTL-Gate correspondence information 60 (ST602).

Then, the RTL description 1 read at step ST601 is divided among the respective logic cones (ST603). In the case of the RTL description 1 of FIG. 3A, a group of the 100th to 115th rows corresponds to a single logic cone.

The process of a logic cone-specific correspondence table creation loop of subsequent steps ST604 to ST611 is performed on every logic cone obtained at step ST603.

Then, input signals to a logic cone that is to be processed are extracted (ST605). In the case of the RTL description 1 of FIG. 3A, the input signals to the logic cone are “a” and “b”.

Then, signals for use in the emulation execution section 54, which correspond to the input signals to the logic cone extracted at step ST605, are extracted (ST606). Hereinafter, the signals for use in the emulation execution section 54 which correspond to the logic cone input signals are referred to as “logic cone gate level block inputs”.

The process of a logic cone input pattern generation loop of subsequent steps ST607 to ST610 is performed on all of the combinations of input signals to the logic cone extracted at step ST605. In the case of the RTL description 1 of FIG. 3A, the process of the logic cone input pattern generation loop is performed on 4 combinations of {a, b}={W1, W2}={0, 0} to {1, 1}.

Then, executed rows of a target logic cone for a target combination pattern are analyzed (ST608). In the case where the target pattern is {a, b}={W1, W2}={0, 0}, the executed rows are the 100th, 101st, 102nd, 113th and 114th rows.

Then, the correspondence between the gate level logic cone inputs and the executed rows, which has been obtained at step ST608, is added to the logic cone input-executed row correspondence table (ST609).

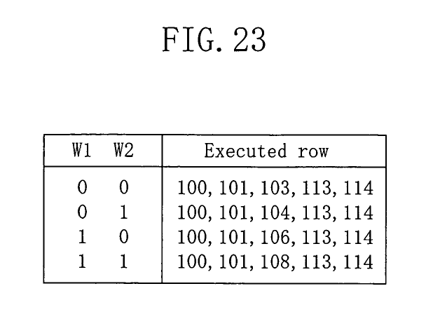

Then, the combination of the input signals to the logic cone is changed, and the process returns to the loop of steps ST607 to ST610. After all of the combinations have been processed, the process proceeds to a next logic cone, and the loop of steps ST604 to ST611 is performed. FIG. 23 shows a logic cone input-executed row correspondence table obtained by performing the above process on the RTL description 1 shown in FIG. 3A.

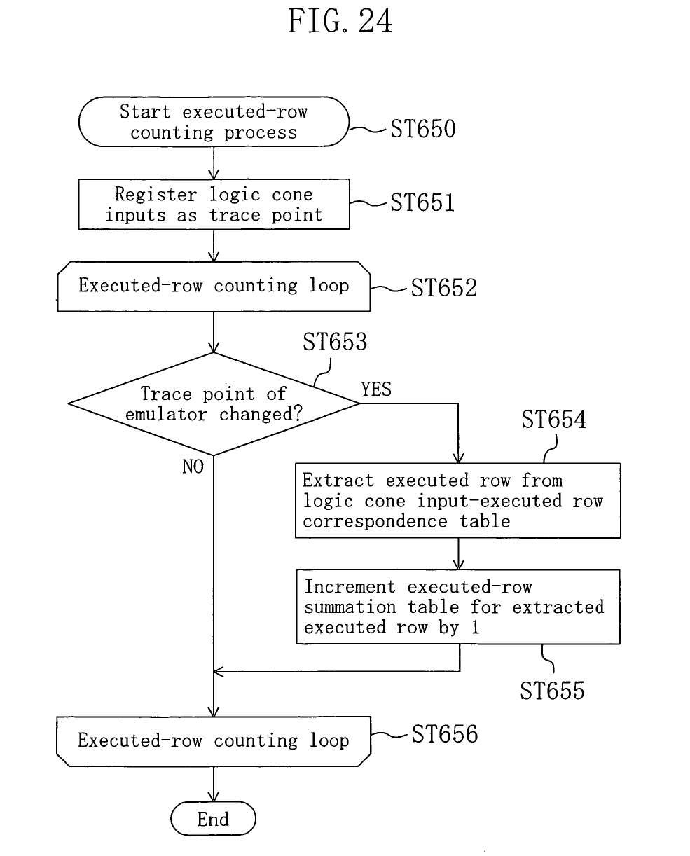

Next, a process performed in the executed-row counting section 62 is described with reference to FIG. 24.

The executed-row counting process is started at the same time with the start of the emulation execution process (ST650).

Then, the gate level logic cone inputs to each of the logic cones obtained in the logic cone input-executed row correspondence table creating section 61 are registered as a trace point used in the emulation execution process (ST651).

The executed-row counting loop of subsequent steps ST652 to ST656 is continued till the emulation execution process is completed.

Then, it is checked whether or not the trace point has been changed in the emulation execution process (ST653). The above-described process up to step ST653 is performed in the logic cone input tracing section 63.

If the trace point has not been changed at step ST653, the process returns to the loop that starts from step ST652. If the trace point has been changed, the executed rows are extracted according to the value of the changed trace point and the logic cone input-executed row correspondence table obtained from the logic cone input-executed row correspondence table creating section 61 (ST654). This process is executed in the executed-row analyzing section 23.

Then, the executed-row summation tables for all of the executed rows extracted at step ST654 are each incremented by 1 (ST655). This process is performed in the executed-row compilation section 12.

Hereinafter, the process returns to the executed-row counting loop that starts from step ST652 to repeat the executed-row counting process till the emulation execution process is completed.

A coverage result obtained by performing the above-described executed-row counting process on the RTL description 1 shown in FIG. 3A and the test vector 2 shown in FIG. 3B is the same as the coverage result 6 shown in FIG. 4.

As described above, according to embodiment 6, the input signals to the logic cone always exist in the gate level netlist 52 even when the optimization process is executed by the logical synthesis section 51. Thus, the coverage can be measured even when the optimization process is executed by the logical synthesis section 51. That is, the optimization process can be carried out even when the coverage is measured. Therefore, the emulation method of embodiment 6 is applicable to a circuit of a larger scale as compared with the emulation method of embodiment 5. Furthermore, the speed of the emulation process is increased.

### Embodiment 7

In the simulation apparatuses of embodiments 2-4, the block input-executed row correspondence table creating section 20 deals with input signals to each description block on a bit-by-bit basis. Thus, as the number of the input signals to the description block is increased, the number of all the combinations of the input signals is accordingly increased to an enormous number which cannot be dealt with. An objective of embodiment 7 is to achieve coverage measurement of a description block which receives many input signals in a simulation of a hardware description language.

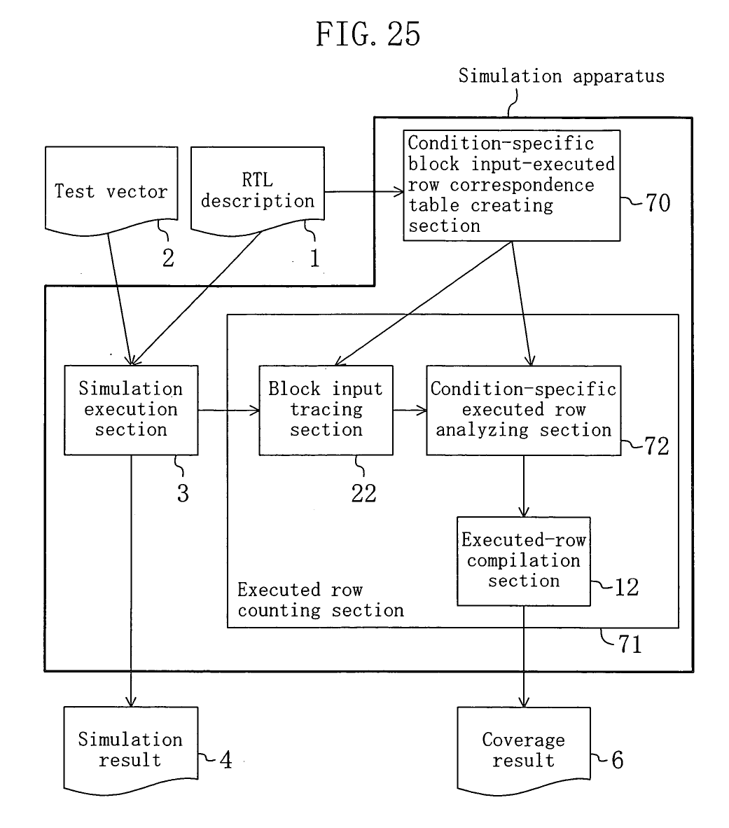

FIG. 25 shows a structure of a simulation apparatus according to embodiment 7. This simulation apparatus includes a simulation execution section 3, a condition-specific block input-executed row correspondence table creating section 70 and an executed row counting section 71.

The condition-specific block input-executed row correspondence table creating section 70 divides a RTL description 1 into description blocks and analyzes, for each description block, the correspondence between the conditions for input signals to the block and the executed rows, thereby extracting correspondence information that represents the correspondence between the conditions for input signals to the block and the executed rows. In the condition-specific block input-executed row correspondence table creating section 70, the execution condition for each row is analyzed, and the input signals to the block are dealt with on a condition-by-condition basis, whereas in the block input-executed row correspondence table creating section 20 of embodiments 2-4 the input signals to the block are dealt with on a bit-by-bit basis.

The executed row counting section 71 includes a block input tracing section 22, a condition-specific executed row analyzing section 72 and the executed-row compilation section 12.

The block input tracing section 22 receives from the simulation execution section 3 input signal information every time any input signal to the description block obtained by the condition-specific block input-executed row correspondence table creating section 70 is changed.

The condition-specific executed row analyzing section 72 extracts executed rows according to the input signal information received by the block input tracing section 22 and the correspondence information that represents the correspondence between the input conditions for the block and the executed rows which has been extracted by the condition-specific block input-executed row correspondence table creating section 70.

The executed-row compilation section 12 counts the number of times of execution for each row based on the executed-row information extracted from the executed-row analyzing section 23 and outputs a coverage result 6 after the simulation execution process is completed.

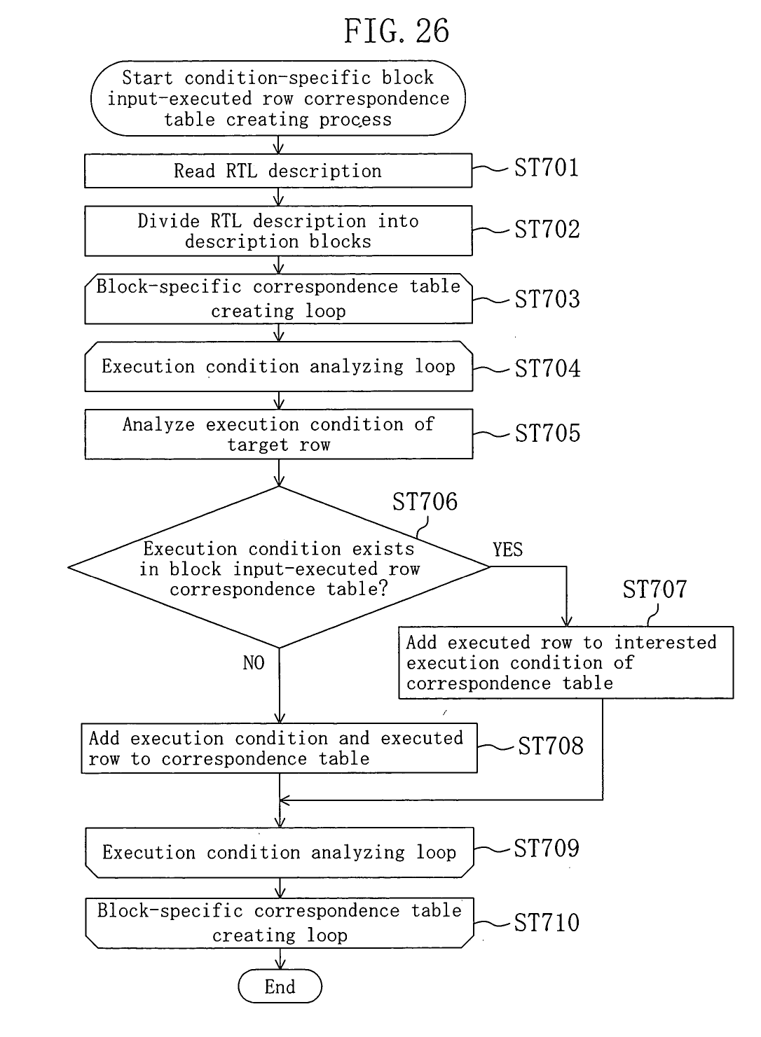

Next, a process performed in the condition-specific block input-executed row correspondence table creating section 70 is described with reference to FIG. 26.

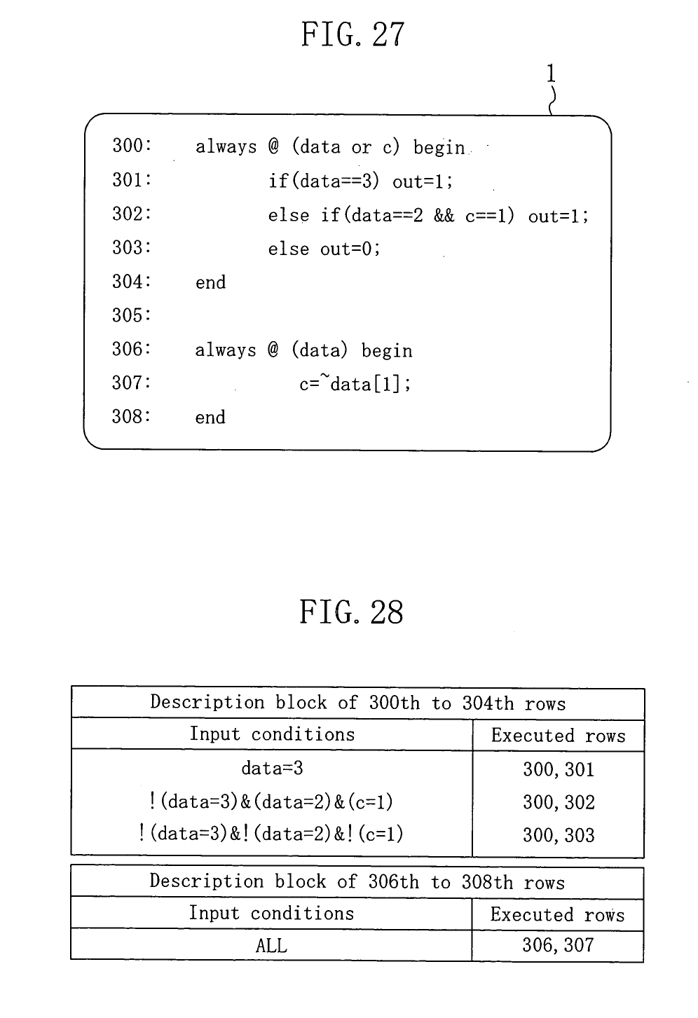

In the first place, the simulation apparatus reads the RTL description 1 (ST701). Herein, it is assumed that the simulation apparatus reads the RTL description 1 shown in FIG. 27.

Then, the read RTL description 1 is divided into description blocks (ST702). Through this process, the read RTL description 1 is divided into the description block of the 300th to 304th rows and the description block of the 306th to 308th rows (see FIG. 27).

The process of a block-specific correspondence table creation loop of subsequent steps ST703 to ST710 is performed on all of the description blocks which are obtained at step ST702. Furthermore, the execution condition analyzing loop of steps ST704 to ST709 is repeated till the analysis for all the rows of a description block to be processed is completed.

Then, the execution condition for an executed row to be processed is analyzed (ST705).

Then, it is checked whether or not the execution condition extracted at step ST705 exists in the condition-specific block input-executed row correspondence table (ST706). If it exists, a currently processed row is added as an executed row to the execution condition in the condition-specific block input-executed row correspondence table (ST707). If it does not exits in the condition-specific block input-executed row correspondence table at step ST706, the execution condition and the executed row are added to the condition-specific block input-executed row correspondence table (ST708).

After the rows of all description blocks have been processed (ST709), the target block is switched to a next description block (ST710), and the process returns to the block-specific correspondence table creation loop that starts from step ST703.

FIG. 28 shows a condition-specific block input-executed row correspondence table which is obtained when the above process is performed on the RTL description 1 of FIG. 27.

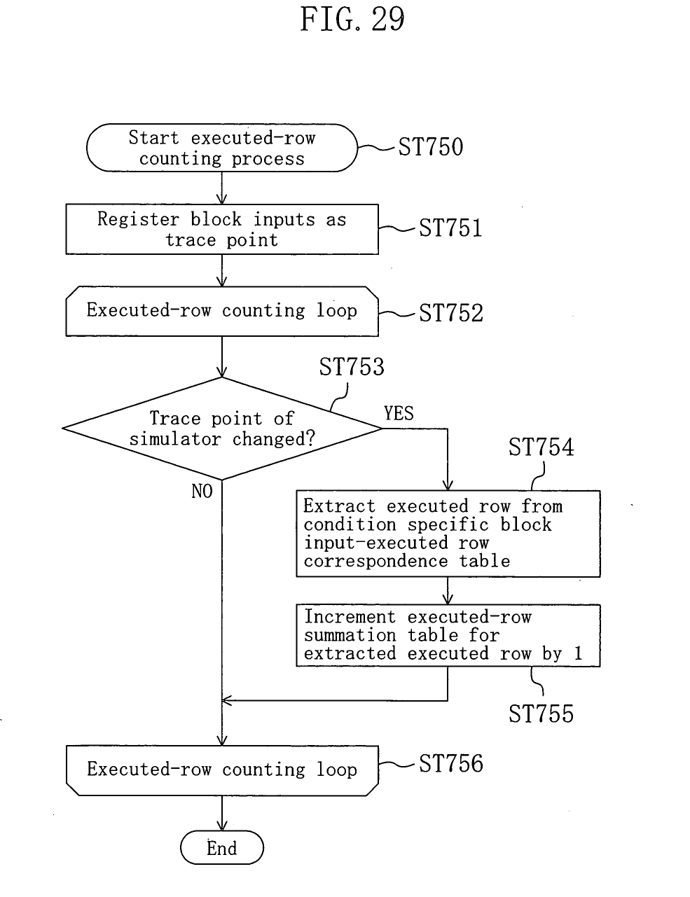

Next, a process performed in the executed row counting section 71 is described with reference to FIG. 29.

The executed-row counting process is started at the same time with the start of the simulation execution process (ST750).

Then, the input signals to each block which are obtained in the condition-specific block input-executed row correspondence table creating section 70 are registered as a trace point used in the simulation execution process (ST751).

The executed-row counting loop of subsequent steps ST752 to ST756 is continued till the simulation execution process is completed.

Then, it is checked whether or not the trace point has been changed in the simulation execution process (ST753). The above-described process up to step ST753 is performed in the block input tracing section 22.

If the trace point has not been changed at step ST753, the process returns to the loop that starts from step ST752. If the trace point has been changed, executed rows corresponding to an interested condition are extracted according to the value of the trace point and the condition-specific block input-executed row correspondence table obtained from the condition-specific block input-executed row correspondence table creating section 70 (ST754). This process is executed in the condition-specific executed row analyzing section 72.

Then, the executed-row summation tables for all of the executed rows extracted at step ST754 are each incremented by 1 (ST755). This process is performed in the executed-row compilation section 12.

After step ST755, the process returns to the executed-row counting loop that starts from step ST752 to repeat the executed-row counting process till the simulation execution process is completed.

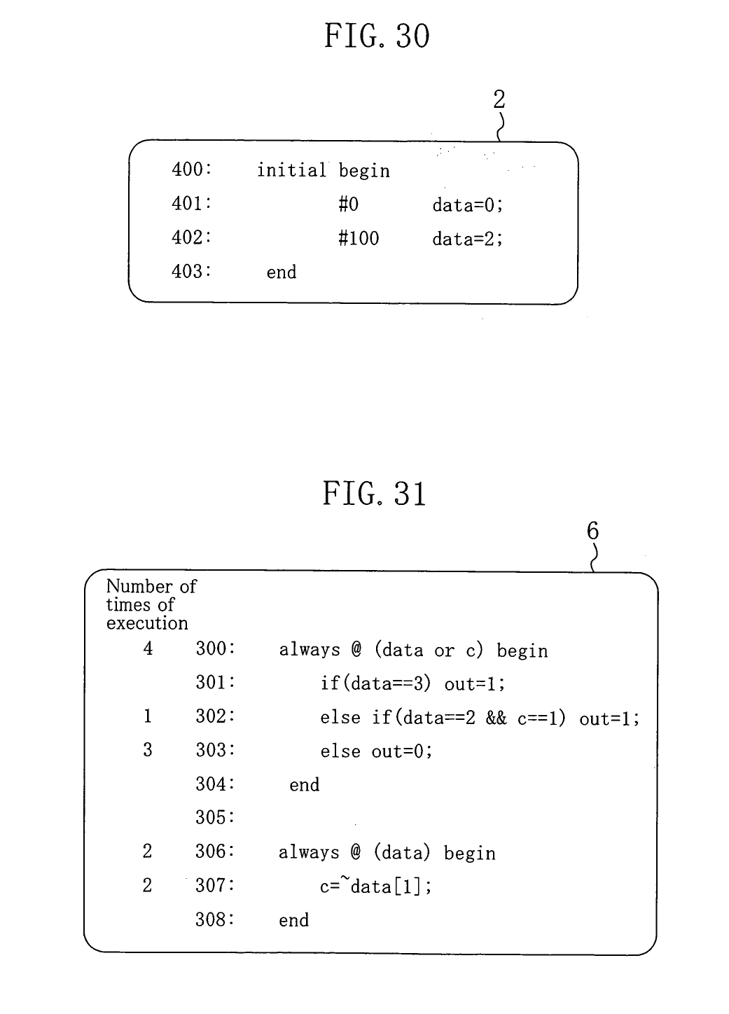

FIG. 31 shows a coverage result 6 obtained by performing the above-described executed-row counting process on the RTL description 1 shown in FIG. 28 and a test vector 2 shown in FIG. 30.

In embodiment 7, the process of preventing an error count in the coverage is not carried out. Thus, the coverage result 6 (FIG. 31) includes an error count. However, if the process of preventing an error count in the coverage which has been described in embodiments 3 and 4 is employed, a correct coverage result which has no error count is obtained.

In embodiment 7, the condition-specific block input-executed row correspondence table creating section 70 establishes the correspondence between the input conditions and the executed rows for each execution condition of each row of the description block on a execution-condition by execution-condition basis, whereas in embodiments 2-4 the correspondence between the description block inputs and the executed rows is established on a bit-by-bit basis. Thus, according to embodiment 7, the coverage measurement can be performed on a description block which receives many input signals.

What is claimed is:

1. A simulation method, comprising the steps of:
recording an executed-row history for each description block; and
if the same description block is performed at the same time, deleting a previous executed-row history of the description block performed at the time.

2. A simulation method, comprising the steps of:
analyzing, for each description block, correspondence information that represents correspondence between combinations of input signals to the description block and executed rows;
in a simulation execution process, tracing input signals to each description block; and
analyzing the executed rows according to an analysis result of the correspondence information that represents the correspondence between combinations of input signals to the description block and executed rows and a trace result of the input signals to the description block.

3. A simulation method, comprising the steps of:
analyzing, for each description block, correspondence information that represents correspondence between combinations of input signals to the description block and executed rows;
in a simulation execution process, tracing input signals to each description block every unit time; and
analyzing the executed rows according to an analysis result of the correspondence information that represents the correspondence between combinations of input signals to the description block and executed rows and a trace result of the input signals to the description block, the trace result being obtained every unit time.

4. A simulation method, comprising the steps of:
analyzing, for each description block, correspondence information that represents correspondence between combinations of input signals to the description block and executed rows;
in a simulation execution process, tracing input signals to each description block every cycle; and
analyzing the executed rows according to an analysis result of the correspondence information that represents the correspondence between combinations of input signals to the description block and executed rows and a trace result of the input signals to the description block, the trace result being obtained every cycle.

5. An emulation method, comprising the steps of:
extracting, for each description block, signals used in a hardware emulation process which correspond to input signals to the description block;
analyzing correspondence information that represents correspondence between combinations of the signals used in hardware emulation process which correspond to input signals to the description block and executed rows;
in an emulation execution process, tracing the signals used in hardware emulation process which correspond to input signals to each description block; and
analyzing executed rows according to the correspondence information that represents the correspondence between the combinations of the signals used in the hardware emulation process which correspond to the input signals to the description block and the executed rows and a result of the tracing of the signals used in the hardware emulation process which correspond to the input signals to the description block.

6. An emulation method, comprising the steps of:
extracting, for each logic cone, signals used in a hardware emulation process which correspond to input signals to the logic cone;
analyzing correspondence information that represents correspondence between combinations of the signals used in the hardware emulation process which correspond to input signals to the logic cone and executed rows;
in an emulation execution process, tracing the signals used in the hardware emulation process which correspond to input signals to each logic cone; and
analyzing executed rows according to the correspondence information that represents the correspondence between the combinations of the signals used in the hardware emulation process which correspond to the input signals to the logic cone and the executed rows and a result of the tracing of the signals used in the hardware emulation process which correspond to the input signals to the logic cone.

7. A simulation method, comprising the steps of:
analyzing, for each description block, input conditions for executing respective rows included in the description block;
analyzing correspondence information that represents correspondence between the input conditions and executed rows;
in a simulation execution process, tracing input signals to each description block; and
analyzing executed rows based on the correspondence information that represents the correspondence between the input conditions and the executed rows and a tracing result of the input signal to the description block.
